(19) United States
(12) Patent Application Publication
(10) Pub. No.: US 2023/0146378 A1
(43) Pub. Date: May 11, 2023

(54) PACKET TRANSFER DEVICE, PACKET TRANSFER METHOD AND PACKET TRANSFER PROGRAM

(71) Applicant: NIPPON TELEGRAPH AND TELEPHONE CORPORATION, Tokyo (JP)

(72) Inventors: Junki ICHIKAWA, Musashino-shi, Tokyo (JP); Tomoya HIBI, Musashino-shi, Tokyo (JP); Hirokazu TAKAHASHI, Musashino-shi, Tokyo (JP); Toru MANO, Musashino-shi, Tokyo (JP)

(73) Assignee: NIPPON TELEGRAPH AND TELEPHONE CORPORATION, Tokyo (JP)

(21) Appl. No.: 17/912,546

(22) PCT Filed: Mar. 24, 2020
(86) PCT No.: PCT/JP2020/012927

§ 371 Date: Sep. 19, 2022

(51) Int. Cl. H04L 45/76; H04L 45/00

(52) U.S. Cl. CPC H04L 45/76; H04L 45/566

(57) ABSTRACT

It is an object of the present disclosure to reduce a packet inflow into the OF controller and suppress a load on the OF controller. The present disclosure provides a packet transfer device, in which: an OpenFlow switch extracts a first packet of a protocol determined in advance, and extracts a second packet in accordance with a rule determined in advance; a NameSpace, connected to the OpenFlow switch via a virtual interface, responds to the extracted first packet to act as proxy for the OpenFlow switch; and a virtual machine, connected to the OpenFlow switch via a virtual interface, processes the extracted second packet to act as proxy for the OpenFlow switch.

### TECHNICAL FIELD

The present disclosure relates to a device, a method, and a program for transferring a packet.

### BACKGROUND ART

A network device called “packet broker” receives an aggregation of packets output from a large number of terminals, and selects, duplicates, rewrites, discards, and transfers the packets. Besides being used to collect a log inside a local network, the device has been given the function of transferring a log packet to an analysis server on the cloud via an encrypted communication path in recent years.

There exists a system in which the device is implemented through OpenFlow (hereinafter denoted as “OF”), which plays the role of the packet broker through matching based on 5-tuple (SIP: source IP address, DIP: destination IP address, PR: IP protocol type, SPT: source port number, and DPT: destination port number) and action on the packets. Advanced processes that cannot be handled by an OF switch, such as ARP (Address Resolution Protocol) resolution, encryption, and encapsulation, are executed by an OF application by a packet inflow into an OF controller (see PTL 1, for example).

### CITATION LIST

### Patent Literature

[PTL 1] Japanese Patent Application Publication No. 2017-153042 (Flow Copy Cast)

### Non Patent Literature

[NPL 1] “OpenStack Docs: Network namespaces”, Apache 2.0 license. https://docs.openstack.org/mitaka/ja/networking-guide/intro-network-namespaces.html

### SUMMARY OF THE INVENTION

### Technical Problem

In a system such as the packet broker in which the OF switch terminates packets with the OF switch itself specified as the destination, an enormous packet inflow into the OF controller is caused when a burst of packets such as those described below occurs, and the OF application may not resist the load and may be abnormally ended.

ARP request transmitted from a terminal upon restoration from a network failure that has occurred

Packets that cannot be processed by the OF switch such as encrypted packets (IPsec) and encapsulated packets (VXLAN)

In order to implement a packet transfer system in which the OF switch itself serves as a termination, it is essential to take measures against a packet inflow, such as providing OF controllers in parallel to avoid load concentration. Thus, it is an object of the present disclosure to reduce a packet inflow into the OF controller and suppress a load on the OF controller.

### Means for Solving the Problem

In order to achieve the foregoing object, the present disclosure proposes a system configuration for a software OF switch system, in which a packet inflow into an OF controller is offloaded. Specifically, a software OF switch device according to the present disclosure causes a NameSpace to execute a proxy response for a lightweight protocol (C-plane), and causes a loopback virtual machine to execute proxy processing for processing not supported by the OF function (D-plane).

The present disclosure provides a packet transfer device, in which:

an OpenFlow switch extracts a first packet of a protocol determined in advance; and

a NameSpace, connected to the OpenFlow switch through a virtual interface, responds to the extracted first packet to act as proxy for the OpenFlow switch.

The present disclosure provides a packet transfer method including:

extracting a first packet of a protocol determined in advance using an OpenFlow switch; and

responding to the extracted first packet, using a NameSpace connected to the OpenFlow switch through a virtual interface, to act as proxy for the OpenFlow switch.

The present disclosure provides a packet transfer device, in which:

an OpenFlow switch extracts a second packet in accordance with a rule determined in advance; and

a virtual machine, connected to the OpenFlow switch through a virtual interface, processes the extracted second packet to act as proxy for the OpenFlow switch.

The present disclosure provides a packet transfer method including:

extracting a second packet in accordance with a rule determined in advance using an OpenFlow switch; and

processing the extracted second packet, using a virtual machine connected to the OpenFlow switch through a virtual interface, to act as proxy for the OpenFlow switch.

The packet transfer program according to the present disclosure is a program for causing a computer to implement functions of the packet transfer device according to the present disclosure, and a program for causing a computer to execute steps of the packet transfer method according to the present disclosure.

### Effects of the Invention

With the present disclosure, it is possible to reduce a packet inflow into the OF controller and suppress a load on the OF controller.

### BRIEF DESCRIPTION OF DRAWINGS

FIG. 1 illustrates an example of the configuration of a server according to the present disclosure.

FIG. 2 illustrates an example of a proxy response made by a NameSpace using a veth-pair.

FIG. 3 illustrates an example of a proxy response made by a NameSpace using a TAP interface.

FIG. 4 illustrates an example of proxy processing performed by a loopback virtual machine using a loopback method with one virtual interface.

FIG. 5 illustrates an example of proxy processing performed by a loopback virtual machine using an in-line processing method with two virtual interfaces.

FIG. 6 illustrates an example of the configuration of an IPsecGW using a loopback virtual machine.

### DESCRIPTION OF EMBODIMENTS

An embodiment of the present disclosure will be described in detail below with reference to the drawings. The present disclosure is not limited to the embodiment described below. The embodiment is merely illustrative, and the present disclosure can be implemented with a variety of modifications and improvements made thereto on the basis of the knowledge of a person skilled in the art. The same reference signs in the specification and the drawings denote identical constituent elements.

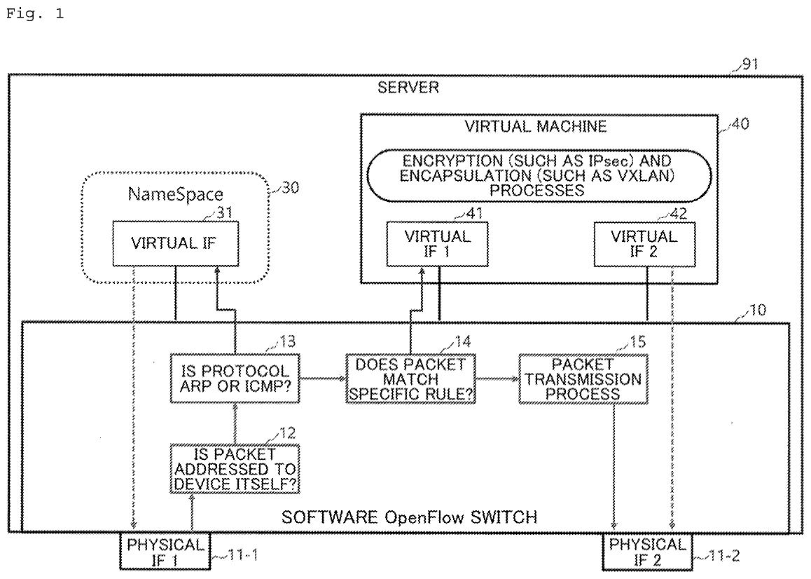

FIG. 1 illustrates an example of the configuration of a server according to the present disclosure. The server 91 includes a software OF switch 10, a NameSpace 30, and a virtual machine 40. The server 91 functions as a packet transfer device according to the present disclosure. The device according to the present disclosure can also be implemented by a computer and a program, and the program can be stored in a storage medium or provided through a network.

The software OF switch 10 includes:

a physical interface 11-1 that receives a packet;

an address determination unit 12 that determines whether the destination address of the packet is the device itself;

a protocol determination unit 13 that determines whether a lightweight protocol such as ARP or ICMP (Internet Control Message Protocol) is used;

a rule determination unit 14 that determines the packet matches a specific rule;

a transmission unit 15 that performs a packet transmission process; and

a physical interface 11-2 that transmits the packet.

The NameSpace 30 is connected to the software OF switch 10 through a virtual interface 31. The NameSpace 30 processes a packet of a lightweight protocol.

The virtual machine 40 is connected to the software OF switch 10 through virtual interfaces 41 and 42. The virtual machine 40 processes a packet that matches the specific rule. In the present disclosure, the virtual machine is occasionally referred to as VM (Virtual Machine).

(NameSpace)

The NameSpace (name space) is a function provided by the Linux kernel (Linux is a registered trademark.) in order to separate resources in the Linux environment (see NPL 1, for example). Specifically, resources for mount, UTS (Unix Time-sharing System), IPC (Inter-Process Communication), PID (process ID), network, and user can be separated. In the present disclosure, Network NameSpace (netns) is used.

The Network NameSpace (netns) is a function of separating the functions about Network of Linux as if there were a plurality of execution environments. The environments separated by netns can have respective independent routing tables and ARP tables, and a packet that has reached an interface assigned by netns is transferred in accordance with the table of each netns. By using netns, a packet that has been received by the OF and that is addressed to the OF itself can be terminated by a dedicated routing engine.

On the other hand, a direct connection to the host Linux system without using netns has a possibility of unexpected behavior because of the effect of the host routing table or iptables filtering, and it is desired that network resources should be separated.

(1) C-plane Proxy Response System Configuration by NameSpace

The NameSpace 30 processes a packet for a lightweight protocol to which the Linux kernel can respond, such as ARP and ICMP. The namespace originally has a function of responding to ARP and ICMP.

Main Elements

1. The NameSpace 30 which is created by the Linux kernel and the physical interface 11-1 which is a port of the software OF switch 10 are connected to each other through the virtual interface 31.

2. An IP address for L3 termination is set on the virtual interface 31 in the NameSpace 30. L3 is a network layer of an OSI (Open Systems Interconnection) reference model.

3. A flow table of the software OF switch 10 is set such that C-plane packets addressed to the IP address for L3 termination flow to the NameSpace 30. The protocol determination unit 13 transfers such packets to the virtual interface 31 in accordance with the flow table.

4. When there is a plurality of IP addresses for L3 termination, sets of each IP address and the virtual interface 31 are created.

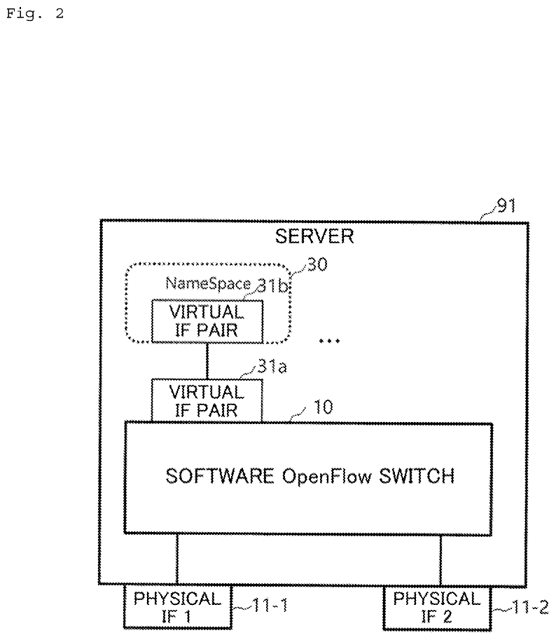

FIG. 2 illustrates an example of a proxy response made by a NameSpace using a veth-pair. A pair of virtual interfaces 31a and 31b are created on Linux, and the virtual interface 31a is assigned to the OF switch software 10 while the virtual interface 31b is assigned to the NameSpace 30.

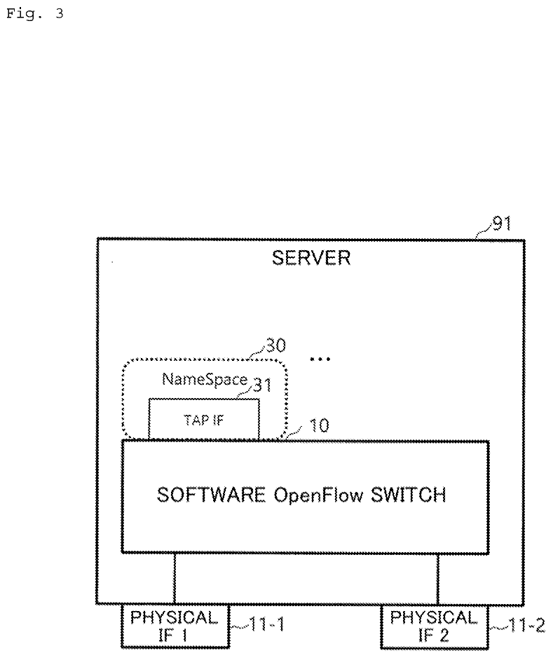

FIG. 3 illustrates an example of a proxy response made by a NameSpace using a TAP interface. The TAP interface 32 is created and assigned to the NameSpace 30 in activation of the software OF switch 10. When the software OF switch 10 uses DPDK (Data Plane Development Kit), a DPDK tap device is created as the virtual interface 31 and the whole tap device is caused to belong to the NameSpace 30 in activation of the software OF switch 10.

(2) D-plane Proxy Processing System Configuration by Loopback Virtual Machine

The virtual machine 40 illustrated in FIG. 1 processes a packet of a protocol not supported by the software OF switch 10, such as for encryption such as IPsec and encapsulation such as VXLAN (Virtual eXtensible Local Area Network), while the processes are D-plane processes.

Main Elements

1. The virtual machine 40 which is created on the host server and the physical interface 11-2 which is a port of the software OF switch 10 are connected to each other through the virtual interface 42.

2. The software OF switch 10 sets a flow table so as to cause a packet to be processed to flow to the virtual interface 41 which is connected to the virtual machine 40. The rule determination unit 14 transfers the packet to be processed to the virtual interface 41 in accordance with the flow table.

3. The virtual machine 40 executes software processing on the packet received from the virtual interface 41, and loops back the packet to the software OF switch 10.

Port termination method: The software OF switch 10 transmits the packet, as it is, to the virtual machine 40 without L3 termination.

IP termination method: L3 termination is made at the reception port of the virtual machine 40. The virtual interface 41 functions as the reception port at which the packet is terminated. The software OF switch 10 secures IP reachability by rewriting the destination MAC address of the packet with the MAC address of the reception port of the virtual machine 40.

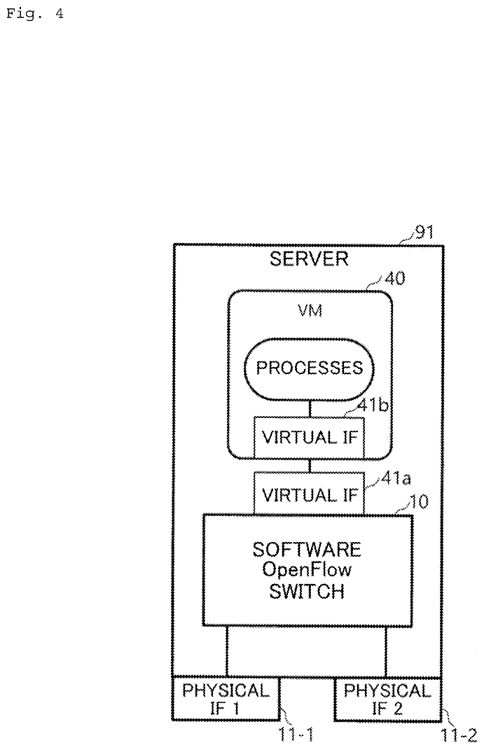

FIG. 4 illustrates an example of proxy processing performed by a loopback virtual machine using a loopback method with one virtual interface. In a service of a server model such as CDN (Content Delivery Network), a packet is often returned with a single interface.

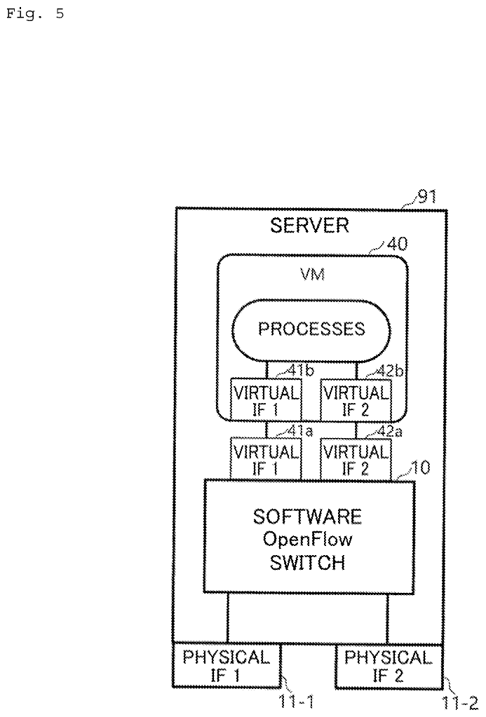

FIG. 5 illustrates an example of proxy processing performed by a loopback virtual machine using an in-line processing method with two virtual interfaces. In a service in which security measures are taken in-line in a network such as IPS (Intrusion Prevention Services), interfaces for sending and returning are often explicitly set.

The software OF switch 10 forwards a packet that matches a specific rule to the virtual machine 40 for loopback. The virtual machine 40 for loopback builds an application required for the service in advance, processes the packet, and returns the packet to the software OF switch 10. The software OF switch 10 further forwards the processed packet.

(IPsecGW Function)

The virtual machine 40 for loopback may execute the function of a software IPsecGW router. The software OF switch 10 rewrites the destination MAC address of only a packet with a specific destination IP address to lead the packet to the virtual machine 40 for loopback. The software OF switch 10 receives a packet encrypted with IPsec from the virtual machine 40, and transfers the packet to the outside.

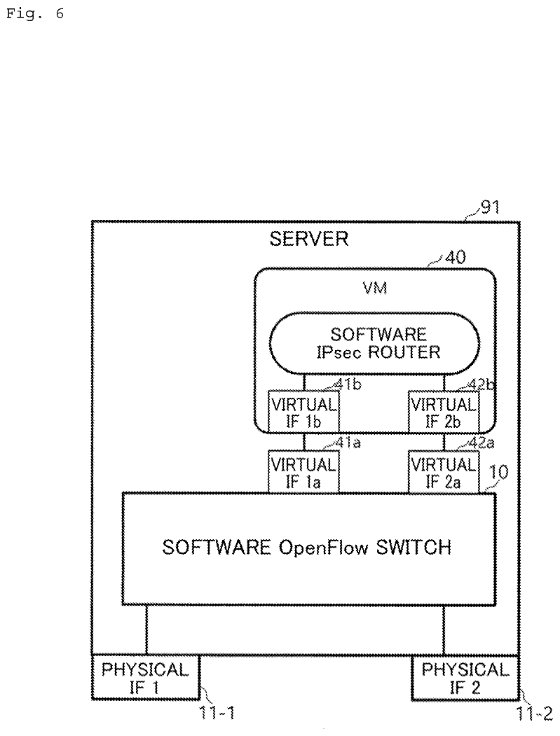

FIG. 6 illustrates an example of the configuration of an IPsecGW which uses a loopback virtual machine. The software OF switch 10 is used to securely transfer a packet to the cloud environment by way of the IPsecGW. The software OF switch 10 and the virtual machine 40 are connected to each other through virtual interfaces 41a and 41b, and 42a and 42b. When the software OF switch 10 encrypts a packet with IPsec, the software OF switch 10 rewrites the destination MAC address to the MAC address of the virtual interface 41b and forwards it to the virtual interface 41a.

In order that the software IPsec router in the virtual machine 40 and the IPsecGW on the cloud side are mutually connected, the physical interface 11-2 port and the virtual interface 42a port of the software OF switch 10 are connected as follows.

A packet received from the virtual interface 42a is transmitted from the physical interface 11-2.

When the destination IP address of a packet received from the physical interface 11-2 is the virtual interface 42b or the IPsec terminal IP of the software IPsec router, the packet is transmitted to the virtual interface 42a.

(Effects Caused by the Invention)

### (1) C-plane Proxy Response System Configuration by NameSpace

With the NameSpace of the host server making a proxy response, it is possible to reduce a packet inflow into the OF controller and suppress a load on the OF controller.

The Linux kernel supports more protocols than C-plane protocols prescribed by the OF, and therefore can respond to more C-plane packets than conventionally.

### (2) D-plane Proxy Processing System Configuration by Loopback Virtual Machine

With the loopback virtual machine of the host server performing proxy processing, it is possible to reduce a packet inflow into the OF controller and suppress a load on the OF controller.

Various software processing that is not limited by the OF function, such as encapsulation and encryption of packets and caching, can be disposed on the virtual machine, and the packet transfer system with the OF can be enhanced.

Effect of Combination of (1) and (2)

In a packet transfer system such as a packet broker in which the OF switch serves as a termination, an enormous packet inflow into the OF controller may be caused, whether C-plane packets or D-plane packets. Reducing a packet inflow and suppressing a load on the OF controller contributes to improving the fault tolerance of the packet transfer system with the OF and extending the service time.

(Points of the Invention)

The invention copes with the vulnerability of the system to an increase in the load due to a packet inflow, which has been problematic with the conventional configuration with an OF switch and an OF controller.

Processing for a lightweight protocol is offloaded to the NameSpace, and processing of D-plane packets which are not supported by the OF is offloaded to the virtual machine, which avoids a system failure even in a high-load network environment and allows operation as the OF switch. There are two methods of a proxy response by the NameSpace, which are different depending on how virtual interfaces are created. There are two methods of proxy processing by the loopback virtual machine, which are different depending on whether IP is terminated or not.

Since an encryption process and an encapsulation process are enabled even in a high-load environment, highly functional OF switches such as an OF switch with an IPsecGW function and an OF switch with a VXLAN overlay function can also be implemented.

### INDUSTRIAL APPLICABILITY

The present disclosure is applicable to the information communication industry.

### REFERENCE SIGNS LIST

10 Software OF switch
11-1, 11-2 Physical interface
12 Address determination unit
13 Protocol determination unit
14 Rule determination unit
15 Transmission unit
20 OF controller
21, 22 Processing unit
30 NameSpace
31, 31a, 31b Virtual interface
40 Virtual machine
41, 41a, 41b, 42, 42a, 42b Virtual interface
91 Server

1. A packet transfer device, wherein:
an OpenFlow switch extracts a first packet of a protocol determined in advance; and
a NameSpace, connected to the OpenFlow switch through a virtual interface, responds to the extracted first packet to act as proxy for the OpenFlow switch.

2. The packet transfer device according to claim 1, wherein
the protocol determined in advance is a protocol to which a Linux kernel can respond.

3. The packet transfer device according to claim 2, wherein:
an IP address is set on the virtual interface of the NameSpace;
in a situation of a packet of the protocol determined in advance and addressed to the device itself, the OpenFlow switch transfers the first packet to the virtual interface of the NameSpace; and
the virtual interface of the NameSpace terminates the packet transferred from the OpenFlow switch.

4. A packet transfer device, wherein:
an OpenFlow switch extracts a second packet in accordance with a rule determined in advance; and
a virtual machine, connected to the OpenFlow switch through a virtual interface, processes the extracted second packet to act as proxy for the OpenFlow switch.

5. The packet transfer device according to claim 4, wherein:
a MAC address is set on the virtual interface of the virtual machine;
in a situation of a packet of a protocol unsupported by the OpenFlow switch and addressed to the device itself, the OpenFlow switch rewrites a destination MAC address of the packet to the MAC address of the virtual interface of the virtual machine, and transfers the second packet to the virtual interface of the virtual machine; and
the virtual interface of the virtual machine terminates the packet transferred from the OpenFlow switch.

6. A packet transfer method comprising:
extracting a first packet of a protocol determined in advance using an OpenFlow switch; and
responding to the extracted first packet, using a NameSpace connected to the OpenFlow switch through a virtual interface, to act as proxy for the OpenFlow switch.

7. A packet transfer method comprising:
extracting a second packet in accordance with a rule determined in advance using an OpenFlow switch; and
processing the extracted second packet, using a virtual machine connected to the OpenFlow switch through a virtual interface, to act as proxy for the OpenFlow switch.

8. A packet transfer program for causing a computer to implement functions of the packet transfer device according to claim 1.
